(19) United States
(12) Patent Application Publication
(10) Pub. No.: US 2004/0060926 A1
(43) Pub. Date: Apr. 1, 2004

(54) Electric heating device comprising a coated heat conductor

(76) Inventor: Michael Weiss, Benediktbeuren (DE)

Correspondence Address: ARTZ & ARTZ, P.C., 28333 TELEGRAPH RD., SUITE 250, SOUTHFIELD, MI, 48034, US

(21) Appl. No.: 10/416,651

(22) PCT Filed: Aug. 30, 2002
(86) PCT No.: PCT/DE02/03186

(30) Foreign Application Priority Data
Sep. 14, 2001 (DE) 101 45 425.2
Jan. 3, 2002 (DE) 102 00 036.0

(51) Int. Cl. H05B 3/44

(52) U.S. Cl. 219/544

(57) ABSTRACT

The present invention relates to an electric heating means (1) having an electric heating conductor (2) covered by an insulating layer (4).

Provision is made so that between the heating conductor (2) and the insulating layer (4), an electrically conductive interlayer (3) is arranged.

The present invention relates to a heating means according to the generic clause of claim 1. Generic heating means are used, for example, for electric heating of furniture, vehicle seats or external systems.

### PRIOR ART

It is known that generic heating means may be installed, for example, under a seat covering of a vehicle seat. Thus, electric heating strands are placed in the seating surface and covered with a covering. To secure the covering against slippage, the covering is connected by seams arranged at regular intervals, for example, to a padding of the seat.

Here the problem arises that heating strands must be oversewn. Thus, damage to the heating strand by needles of a sewing machine is possible. In an extreme case, severance of the strand may result. This leads to total failure of the heating means. In such case, the seat must be repaired at considerable expense or completely scrapped.

It is known further that heating strands may be jacketed with an insulating layer. However, this insulating layer must be flexible. Therefore, the insulating layer can only inadequately protect a heating strand from damage by sewing needles.

### OBJECT OF THE INVENTION

The invention relates to a heating means having the features of claim 1. It has the advantage that the interlayer 3, in event of damage to the heating conductor 2, may serve as a current by-pass. In this way, a flow of current through the heating means 1 is assured even in case of damage to the heating conductor 2.

The heating means according to claim 2 will withstand high mechanical overloading.

The heating means according to claim 3 comprises a flexible and electrically conductive interlayer, capable also of being brought into close contact with the surface of the heating strand. As a result, transfer resistances are low.

A heating means according to claim 4 is of a simple and corrosion-protected structure.

A heating means according to claim 5 ensures that in event of failure of the heating conductor 2, the interlayer 3 will not be endangered by an undue current load.

A heating means according to claim 6 permits a simple and wide-area placement of heating conductors.

### FIGUR S

The description to follow deals with possible conformations of the invention. These embodiments are to be understood as examples only, and are executed with reference to:

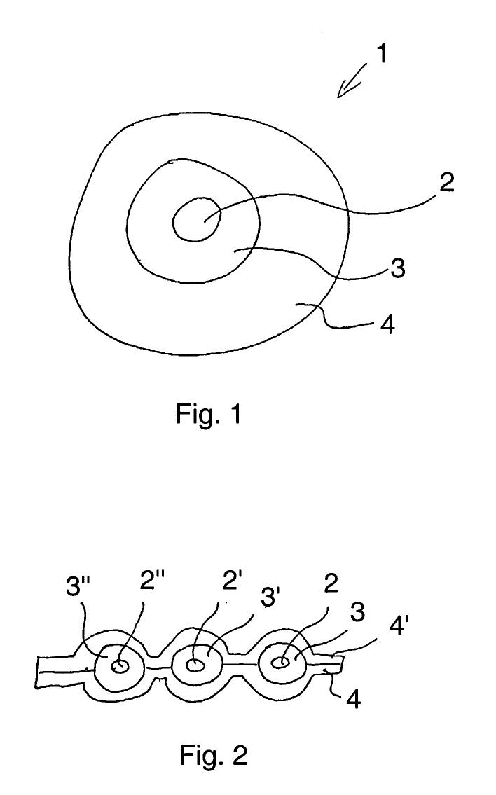

FIG. 1 Cross section of a heating conductor according to the invention;

FIG. 2 Cross section of a flat strip cable with heating conductors according to the invention.

### DESCRIPTION OF THE INVENTION

FIG. 1 shows a heating means 1. This possesses an electric heating conductor 2. The heating conductor 2 is surrounded by an electrically conductive interlayer 3. The electric heating conductor 2 with its interlayer 3 is surrounded by an insulating layer 4.

The electric heating conductor 2 is preferably a metallic conductor. Owing to the relief of the heating conductor 2 by the interlayer 3, the heating conductor of the present invention may have less mechanical load capacity than in conventional solutions. Thus, for example, instead of a costly precious-metal strand, a more economical copper strand may be used.

The interlayer 3 consists preferably of a synthetic material. This may itself be electrically conductive. Alternatively, however, electrically conductive particles, for example of graphite or metal, may be mixed in. Instead of a coating with synthetic material, an application of powdered graphite would also be conceivable. This would then be present loose between the heating conductor 2 and the interlayer 3.

The insulating layer 4 may be a conventional synthetic insulation. In the present example, it is a halogen-free synthetic material.

When the heating means 1 is switched on, the heating conductor 2 is supplied with current. As a result of its electrical resistance, the heating conductor 2 will be heated. In undamaged condition, very little current will flow through the interlayer 3. This is ensured by a higher specific resistance of the interlayer 3 than of the heating conductor 2.

If damage to the heating conductor 2 results in a weakening of its conductor cross-section, then its electrical resistance will increase at this point. As a result, the current will escape locally into the surrounding interlayer 3. After bypassing the damaged part of the heating conductor 2 by way of the interlayer 3, the current will continue to flow in its original direction in the heating conductor 2 once more.

FIG. 2 shows a flat strip cable having three heating conductors 2, 2′, 2″. Each of these is surrounded by an interlayer 3, 3′, 3″ of its own. The heating conductors 2, 2′, 2″ run parallel to each other at regular intervals. They are covered on their under side by an insulating layer 4 and on top by an insulating layer 4′. The insulating layers 4, 4′ are connected to each other on either side of a heating conductor 2, 2′, 2″. They thus form the outer layer of a flat strip cable.

1. Electric heating means (1) having an electric heating conductor (2) covered at least partly by an insulating layer (4), characterized in that between the heating conductor (2) and the insulating layer (4), an electrically conductive interlayer (3) is arranged.

2. Heating means according to claim 1, characterized in that the electric conductor (2) is a metallic strand.

3. Heating means according to either of the preceding claims, characterized in that the interlayer is at least partly of a synthetic material and/or of graphite and/or of electrically conductive particles of material.

4. Heating means according to any of the preceding claims, characterized in that the heating conductor (2) is of wire or strip form, and the interlayer (3) jackets the electric heating conductor (2) substantially all over.

5. Heating means according to any of the preceding claims, characterized in that the cross section of the interlayer (3) comprises an at least similar current-carrying capacity in the direction of flow to the electric heating conductor (2).

6. Heating means according to any of the preceding claims, characterized in that at least two heating conductors (2, 2′, 2″) are at least partly covered, each by its own interlayer (3, 3′, 3″), and each of these interlayers (3, 3′, 3″) is at least in part covered in turn by at least one insulating layer (4, 4′).
